(19) United States
(12) Patent Application Publication
(10) Pub. No.: US 2018/0187722 A1
(43) Pub. Date: Jul. 5, 2018

(54) RETAINER AND DEEP GROOVE BALL BEARING

(71) Applicant: NTN CORPORATION, Osaka (JP)

(72) Inventor: Katsuaki SASAKI, Shizuoka (JP)

(21) Appl. No.: 15/736,488

(22) PCT Filed: Jun. 2, 2016
(86) PCT No.: PCT/JP2016/066441

§ 371 Date: Dec. 14, 2017

(30) Foreign Application Priority Data
Jun. 22, 2015 (JP) 2015-124579

(51) Int. Cl. F16C 33/38; F16C 33/42; F16C 19/06

(52) U.S. Cl. CPC F16C 33/3887; F16C 2326/06; F16C 19/06; F16C 33/427

(57) ABSTRACT

Provided is a retainer (7), including a pair of annular members (8, 8), the pair of annular members (8, 8) being coupled to each other so that semispherical bulging portions (9, 9) which are opposed to each other form pockets (11) configured to retain balls (6). The pockets (11) each include a ball-opposed surface (12) having a ball non-contact portion (14) that is recessed toward a side opposite to the ball side. The ball non-contact portion (14) is formed outside a predetermined region (A) of the ball-opposed surface (12), which includes an intersection (P) of a pitch circle (PCD) of the balls (6) and a straight line (L) extending in a radial direction through a central portion of the ball-opposed surface (12) in a circumferential direction, and has an end portion on a radially outer side which is opened in a radially outer surface (8a) of the annular member (8).

### TECHNICAL FIELD

The present invention relates to a retainer and a deep groove ball bearing including the same.

### BACKGROUND ART

As is well known, a deep groove ball bearing (hereinafter also simply referred to as “ball bearing”), which is a type of a rolling bearing, includes an inner ring, an outer ring, and a retainer. The inner ring and the outer ring rotate relative to each other through intermediation of a plurality of balls. The retainer is arranged between the inner ring and the outer ring and is configured to retain the balls at predetermined intervals in a circumferential direction.

As a retainer 100 for a ball bearing, for example, a so-called corrugated retainer is used in many cases. As illustrated in FIG. 10, the corrugated retainer includes a pair of annular members 101 and 101 each having semispherical bulging portions 102 arrayed at predetermined intervals along a circumferential direction. The pair of annular members 101 and 101 are coupled to each other with use of fasteners 104 such as rivets so that the semispherical bulging portions 102 and 102 which are opposed to each other form pockets 103 configured to retain balls.

Incidentally, particularly for a ball bearing that is to be incorporated into a drive system of an automobile such as a transmission, reduction in torque has been strongly demanded in order to promote reduction in fuel consumption of an automobile. In the ball bearing, various factors may cause generation of torque. Factors related to the retainer which may cause generation of torque are dominated by a shear resistance that is generated by shearing of an oil film formed between balls and pockets along with rolling of the balls and a resistance that is generated when a lubricant such as a lubricating oil passes through small gaps (pocket gaps) between the balls and the pockets.

Therefore, the applicant of the present application has proposed the following retainer in Patent Literature 1 described below. That is, in the proposed retainer, pockets each include a ball-opposed surface (inner surface of a semispherical bulging portion) having a ball non-contact portion that is recessed toward a side opposite to the ball side. With such a configuration, a contact area between the pockets and the balls is reduced by the range of from 15% to 30% as compared to a contact area between pockets and balls in a case in which no ball non-contact portion is formed in each pocket. When such a ball non-contact portion is formed, a gap width of a pocket gap is partially increased. Therefore, the resistance that is generated when the lubricant passes through the pocket gaps can be reduced. Further, the shear resistance of the oil film formed between the pockets (ball-opposed surfaces) and the balls can be reduced. This is because the shear resistance of the oil film increases in reverse proportion to the thickness of the oil film. In particular, the amount of reduction in contact area between the pockets and the balls through formation of the ball non-contact portions is set so as to fall within the above-mentioned range, and hence favorable operability of the balls as well as the ball bearing can be secured while the bearing torque is effectively reduced through reduction of the above-mentioned various resistances.

### CITATION LIST

Patent Literature: JP 2009-299813 A

### SUMMARY OF INVENTION

### Technical Problem

According to studies conducted by the inventor of the present invention, it has been found that, in the retainer having the configuration of Patent Literature 1, each ball non-contact portion is formed in a region of the ball-opposed surface in which contact with the ball is highly frequent. Therefore, noise is liable to occur during operation of the bearing. Further, it has also been found that there is a case in which appropriate torque transmission is not performed between the inner ring and the outer ring. Further, in recent years, competition for reduction in fuel consumption of an automobile has become more severe. Therefore, there is need for further reduction in torque of the ball bearing.

In view of the above-mentioned circumstances, an object of the present invention is to provide a retainer which is capable of further reducing bearing torque and achieving a ball bearing which is quiet and excellent in torque transmission performance between an inner ring and an outer ring.

### Solution to Problem

According to one embodiment of the present invention devised to achieve the above-mentioned object, there is provided a retainer, comprising a pair of annular members each having semispherical bulging portions arrayed at predetermined intervals along a circumferential direction, the pair of annular members being coupled to each other so that the semispherical bulging portions which are opposed to each other form pockets configured to retain balls, the pockets each comprising a ball-opposed surface having a ball non-contact portion that is recessed toward a side opposite to the ball side, the ball non-contact portion being formed outside a predetermined region of the ball-opposed surface, which includes an intersection of a pitch circle of the balls and a straight line extending in a radial direction through a central portion of the ball-opposed surface in the circumferential direction, and having an end portion on a radially outer side which is opened in a radially outer surface of the annular member. The “circumferential direction” and the “radial direction” referred to herein in relation to the present invention correspond to a circumferential direction and a radial direction of the ball bearing (deep groove ball bearing), respectively, into which the retainer according to the present invention is incorporated.

According to the present invention, the ball non-contact portion is formed outside the predetermined region of the ball-opposed surface, which includes the intersection of the pitch circle of the balls and the straight line extending in the radial direction through the central portion of the ball-opposed surface in the circumferential direction (in short, a substantially central portion of the ball-opposed surface), that is, in a region in which contact with the ball is less frequent. Therefore, while the torque reduction effect through formation of the ball non-contact portion is effectively achieved, occurrence of collision sound (noise) caused by wobbling of the balls in the pockets and degradation in torque transmission performance between the inner ring and the outer ring can be prevented as much as possible. Further, an end portion of the ball non-contact portion on the radially outer side is opened in the radially outer surface of the annular member (semispherical bulging portion). Therefore, a lubricant interposed between the pockets and the balls can smoothly be discharged to the outside of the retainer. With this, in particular, the shear resistance of an oil film caused by the ball can be further reduced, and the bearing torque can be further reduced. As described above, according to the present invention, the ball bearing which is further reduced in torque and is quiet and excellent in torque transmission performance between the inner ring and the outer ring can be achieved.

In the above-mentioned configuration, when the ball non-contact portion has a wedge-shaped cross section which gradually increases in separation distance with respect to the ball from a radially inner side to the radially outer side, the lubricant can be more smoothly discharged to the outside of the retainer along with the action of the centrifugal force on the lubricant interposed between the pockets and the balls during the operation of the bearing. With this configuration, increase in torque due to interposition of a surplus lubricant between the pockets and the balls can be suppressed. Further, the peripheral speed of the ball is higher on the radially outer side. Therefore, when the ball non-contact portion has the wedge-shaped cross section as described above, it is advantageous in view of reducing the shear resistance of the oil film caused by the ball.

An end portion of the ball non-contact portion on the radially inner side can be ended within the range of the ball-opposed surface, or can be opened in a radially inner surface of the annular member. Further, the ball non-contact portion can be formed at each of two locations apart in the circumferential direction.

The ball non-contact portion can be formed of, for example, a recessed portion that is formed in the ball-opposed surface through formation of a protruding portion protruding toward the side opposite to the ball side in the semispherical bulging portion.

In the configuration described above, the pair of annular members may be any one product selected from the group consisting of, for example, a press-formed product that is formed by press-working on a metal plate, a casted product, a machined product that is manufactured by machining such as cutting on metal or resin, and an injection-molded product of resin or metal.

When the retainer according to the present invention is used for a deep groove ball bearing comprising an outer ring and an inner ring which rotate relative to each other through intermediation of a plurality of balls, and a retainer which is arranged between the outer ring and the inner ring and is configured to retain the plurality of balls, a deep groove ball bearing which is further reduced in torque can be achieved with the above-mentioned features of the retainer according to the present invention. Thus, when the deep groove bearing is used through incorporation into, for example, a transmission of an automobile, it can contribute to reduction in fuel consumption of the automobile.

### Advantageous Effects of Invention

As described above, according to the present invention, it is possible to provide the retainer which is capable of further reducing the bearing torque and achieving the ball bearing which is quiet and excellent in torque transmission performance between the inner ring and the outer ring.

### BRIEF DESCRIPTION OF DRAWINGS

FIG. 1 is a sectional view of a deep groove ball bearing which includes a retainer according to a first embodiment of the present invention.

FIG. 2 is a partial plan view of the retainer illustrated in FIG. 1 as seen from a radially outer side.

FIG. 3A is a partial perspective view of an annular member on one side which constructs the retainer illustrated in FIG. 1, and is a partial perspective view of the annular member as seen from a radially inner side.

FIG. 3B is a partial perspective view of the annular member on the one side which constructs the retainer illustrated in FIG. 1, and is a partial perspective view of the annular member as seen from the radially outer side.

FIG. 4 is a partial developed plan view of the annular member on the one side which constructs the retainer illustrated in FIG. 1 as seen from the radially inner side.

FIG. 5 is a partial perspective view of a retainer according to a second embodiment of the present invention in which balls are incorporated into pockets.

FIG. 6A is a partial perspective view of an annular member on one side which constructs the retainer illustrated in FIG. 5, and is a partial perspective view of the annular member as seen from the radially inner side.

FIG. 6B is a partial perspective view of the annular member on the one side which constructs the retainer illustrated in FIG. 5, and is a partial perspective view of the annular member as seen from the radially outer side.

FIG. 7 is a partial developed plan view of the annular member on the one side which constructs the retainer illustrated in FIG. 5 as seen from the radially inner side.

FIG. 8A is a schematic view for illustrating a first lubrication condition that is employed at the time of implementation of a torque measurement test for the ball bearing.

FIG. 8B is a schematic view for illustrating a second lubrication condition that is employed at the time of implementation of a torque measurement test for the ball bearing.

FIG. 9A is a graph for showing a torque measurement result that was given in the case in which the ball bearing was operated under the lubrication condition illustrated in FIG. 8A.

FIG. 9B is a graph for showing a torque measurement result that was given in the case in which the ball bearing was operated under the lubrication condition illustrated in FIG. 8B.

FIG. 10 is a partial perspective view of a related-art retainer for a ball bearing.

### DESCRIPTION OF EMBODIMENTS

Now, embodiments of the present invention are described with reference to the drawings.

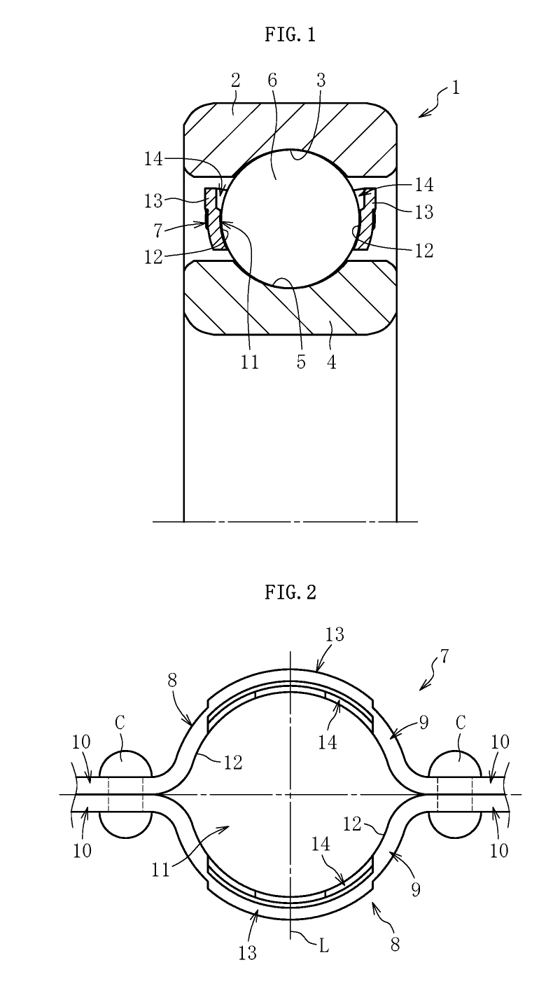

FIG. 1 is a partial sectional view of a deep groove ball bearing (hereinafter referred to as “ball bearing”) which comprises a retainer according to a first embodiment of the present invention. The ball bearing 1 is to be used through incorporation into, for example, a transmission which constructs a drive system of an automobile. The ball bearing 1 comprises an outer ring 2, an inner ring 4, a plurality of balls 6, and a retainer 7. The outer ring 2 has an arc-shaped outer raceway surface 3 along an inner periphery thereof. The inner ring 4 has an arc-shaped inner raceway surface 5 along an outer periphery thereof. The plurality of balls 6 are arranged between the outer raceway surface 3 and the inner raceway surface 5 so as to be rollable. The retainer 7 is configured to retain the balls 6 at predetermined intervals in a circumferential direction. Lubrication for an inside of the ball bearing 1 is performed, for example, with use of a lubricating oil fed from an oil-feeding mechanism (not shown) or through operation of the ball bearing 1 under a state in which the ball bearing 1 is partially immersed in the lubricating oil.

The retainer 7 is a so-called corrugated retainer having the following configuration. As illustrated in FIG. 2, the retainer 7 includes a pair of annular members 8 and 8 each integrally including semispherical bulging portions 9 and connection portions 10. The semispherical bulging portions 9 are arrayed at predetermined intervals along the circumferential direction. The connection portions 10 are configured to connect adjacent semispherical bulging portions 9 to each other. The pair of annular members 8 and 8 are coupled to each other with use of fasteners C such as rivets. The annular members 8 and 8 are coupled to each other by the fasteners C under a state in which the connection portions 10 of one annular member 8 are held in abutment against the connection portions 10 of another annular member 8. Therefore, under the state in which the annular members 8 and 8 are coupled to each other, the spherical bulging portions 9 of the one annular member 8 and the spherical bulging portions 9 of the another annular member 8 are opposed to each other, thereby forming pockets 11 configured to retain the balls 6.

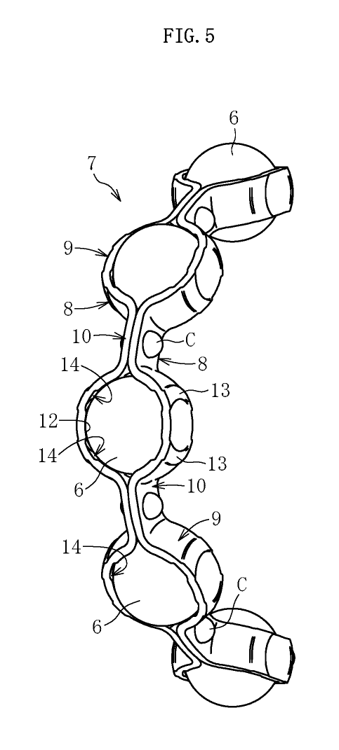

An inner surface of each semispherical bulging portion 9, that is, a ball-opposed surface 12 of each pocket 11 has a recessed ball non-contact portion 14 that is recessed toward a side opposite to the ball side. As illustrated in FIG. 4, the ball non-contact portion 14 is formed outside a predetermined region A of the ball-opposed surface 12, which includes an intersection P of a pitch circle PCD of the balls 6 and a straight line L extending in the radial direction (up-and-down direction in the drawing sheet of FIG. 4) through a central portion of the ball-opposed surface 12 in the circumferential direction. An end portion of the ball non-contact portion 14 on a radially outer side is opened in a radially outer surface 8a of the annular member 8, that is, a radially outer surface of the semispherical bulging portion 9. An end portion of the ball non-contact portion 14 on a radially inner side is not opened in a radially inner surface 8b of the annular member 8, and is ended within a range of the ball-opposed surface 12. The ball non-contact portion 14 of the first embodiment is arranged at a substantially central portion of the ball-opposed surface 12 in the circumferential direction. The ball non-contact portion 14 has a substantially U-shape including a first portion and a pair of second portions. The first portion has an end portion on the radially inner side which is ended relatively on the radially outer side. The pair of second portions are arranged on both sides of the first portion in the circumferential direction, and each have an end portion on the radially inner side which is ended relatively on the radially inner side. The entire ball non-contact portion 14 is arranged on the radially outer side with respect to the pitch circle PCD.

Further, as illustrated in FIG. 1, the ball non-contact portion 14 of the first embodiment has a wedge-shaped cross section which gradually increases in separation distance (separation distance in an axial direction) with respect to the ball 6 from the radially inner side to the radially outer side.

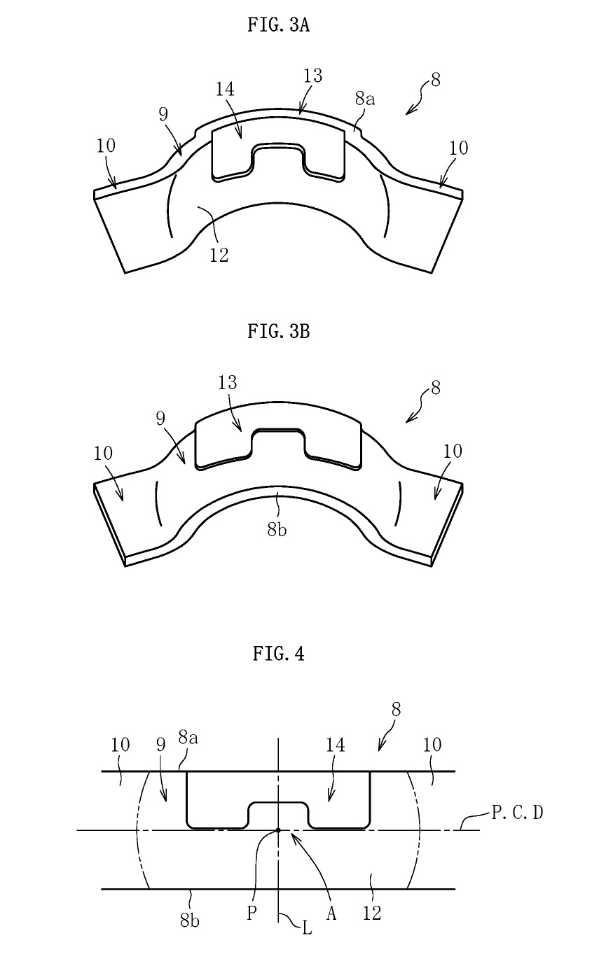

The annular member 8 having the above-mentioned configuration is a press-formed product that is formed by press-working on a metal plate. That is, portions of the annular member 8 such as the semispherical bulging portions 9 and the ball non-contact portions 14 are formed by press-working on a metal plate. As illustrated in FIG. 3A and FIG. 3B, the semispherical bulging portion 9 having a protruding portion 13 protruding toward the side opposite to the ball side is formed along with the press-working. As a result, the ball non-contact portion 14 is constructed by a recessed portion formed in the ball-opposed surface 12. As a metal plate for use in forming the annular member 8, there may be used a cold-rolled steel plate member such as SPCC or SPCD.

As described above, in the retainer 7 according to the present invention, the ball non-contact portion 14 is formed outside the predetermined region A of the ball-opposed surface 12, which includes the intersection P of the pitch circle PCD of the balls 6 and the straight line L extending in the radial direction through the central portion of the ball-opposed surface 12 in the circumferential direction, that is, a region in which contact with the ball 6 is less frequent (region in which contact is substantially zero). Therefore, while the torque reduction effect through formation of the ball non-contact portion 14 is effectively achieved, occurrence of noise caused by wobbling of the ball 6 in the pocket 11 and degradation in torque transmission performance between the outer ring 2 and the inner ring 4 can be prevented as much as possible.

Further, the end portion of the ball non-contact portion 14 on the radially outer side which is formed in the semispherical bulging portion 9 is opened in the radially outer surface 8a of the annular member 8, and hence the lubricating oil that is fed from the oil-feeding mechanism (not shown) and interposed between the pocket 11 and the ball 6 can be smoothly discharged to the outside of the retainer 7. Further, in the first embodiment, the ball non-contact portion 14 has a wedge-shaped cross section which gradually increases in separation distance with respect to the ball 6 from the radially inner side to the radially outer side. Therefore, the lubricating oil interposed between the pocket 11 and the ball 6 can be more smoothly discharged to the outside of the retainer 7 by the centrifugal force that acts on portions of the bearing along with operation of the ball bearing 1. Further, in the first embodiment, the ball non-contact portion 14 has the wedge-shaped cross section as described above, and the entirety of the ball non-contact portion 14 is arranged on the radially outer side with respect to the pitch circle PCD of the balls 6. Therefore, the shear resistance of the oil film at a position with higher peripheral speed can be reduced. With the synergy of those effects, significant reduction in torque of the ball bearing 1 can be achieved.

As described above, with use of the retainer 7 according to the present invention, there can be achieved the ball bearing 1 that is quiet and excellent in torque transmission performance between the rings 2 and 4, and is significantly reduced in torque. Thus, when the ball bearing 1 is used for a drive system of an automobile, it can contribute to reduction in fuel consumption of the automobile.

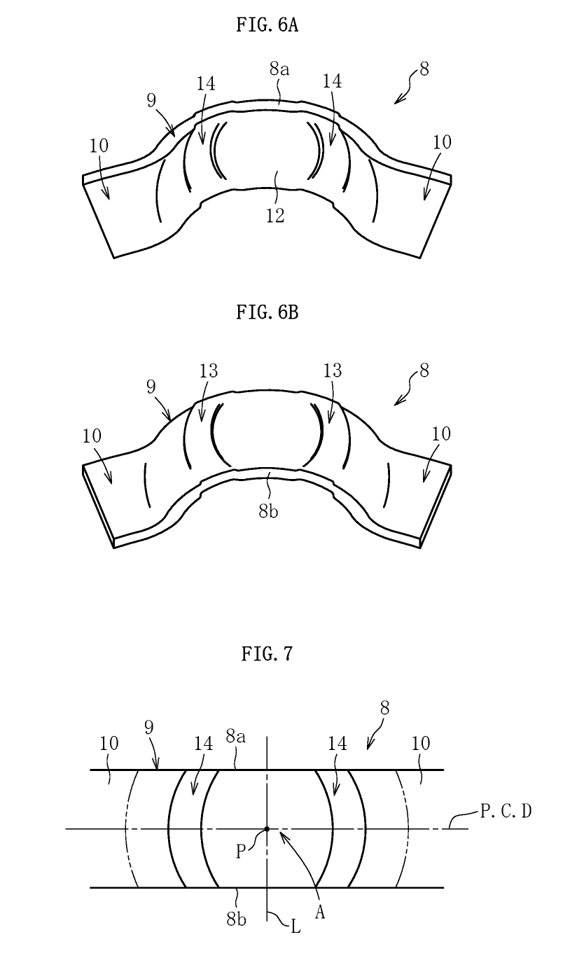

FIG. 5 is a partial perspective view of the retainer 7 for a ball bearing according to a second embodiment of the present invention. FIG. 6A and FIG. 6B are partial perspective views of the annular member 8 on one side which constructs the retainer 7. FIG. 7 is a partial developed plan view of the annular member 8 as seen from the radially inner side.

The retainer 7 according to the second embodiment is mainly different from the retainer 7 according to the above-mentioned first embodiment in that the ball non-contact portion 14 to be formed in the ball-opposed surface 12 is formed at each of two locations apart in the circumferential direction in the ball-opposed surface 12. More in detail, the ball non-contact portion 14 is formed on each of both sides in the circumferential direction of the predetermined region A of the ball-opposed surface 12, which includes the intersection P of the pitch circle PCD of the balls 6 and the straight line L extending in the radial direction through the central portion of the ball-opposed surface 12 in the circumferential direction. Further, the end portions of each ball non-contact portion 14 on the radially outer side and the radially inner side are opened in the radially outer surface 8a and the radially inner surface 8b of the annular member 8, respectively. In the illustrated example, each ball non-contact portion 14 has an arc shape that is curved with respect to the radial direction.

Also in this case, through formation of the ball non-contact portions 14 in the above-mentioned mode, while the torque reduction effect is effectively achieved, occurrence of noise caused by wobbling of the balls 6 in the pockets 11 and degradation in torque transmission performance between the rings 2 and 4 can be prevented as much as possible. Further, the end portions of each ball non-contact portion 14 on the radially outer side and the radially inner side are opened in the radially outer surface 8a and the radially inner surface 8b of the annular member 8, respectively. Therefore, flowability of the lubricating oil between the pocket 11 and the ball 6 is improved, thereby being capable of reducing torque.

Although detailed illustration is omitted, the ball non-contact portion 14 of the second embodiment may be constructed by a recessed portion which is entirely uniform in depth dimension (separation distance with respect to the ball 6), or may have the wedge-shaped cross section which gradually increases in separation distance with respect to the ball 6 from the radially inner side to the radially outer side as in the above-mentioned first embodiment.

In the above, description is made of the retainer 7 and the ball bearing 1 comprising the retainer 7 according to the embodiments of the present invention. However, various modifications can be made to those embodiments within the range of not departing from the gist of the present invention.

For example, the pair of annular members 8 and 8 which construct the retainer 7 each may be a press-formed product of a metal plate, or may be a casted product, a machined product that is manufactured by machining such as cutting on metal or resin, or an injection-molded product of resin or metal. When the annular member 8 is an injection-molded product of resin, for example, the annular member 8 can be formed by injection molding through use of a resin material having a base resin of any one material selected from the group consisting of polyphenylene sulfide (PPS), polyamide (PA), polyimide (PI), polyamide imide (PAI), and polyetheretherketone (PEEK). The base resin to be used can be suitably selected in accordance with requested properties.

Moreover, in the above, description is made of the case in which the retainer 7 according to the present invention is used for a so-called open-type ball bearing 1 having no seal portion (seal function). However, the retainer 7 according to the present invention is also applicable to a so-called sealed-type ball bearing. Although illustration is omitted, in the sealed-type ball bearing, seal members, which may be of a contact type or a non-contact type, are mounted and fixed to both sides of the ball 6 in the axial direction, and a lubricant such as a lubricating oil or a lubricating grease is charged and sealed in an annular space defined between the seal members.

The present invention is not limited to the above-mentioned embodiments. As a matter of course, the present invention may be carried out in various modes within the range of not departing from the gist of the present invention. The scope of the present invention is defined in claims, and encompasses equivalents described in claims and all changes within the scope of claims.

### Example

In order to verify the usability of the present invention, an open-type ball bearing into which the retainer having the configuration of the present invention was incorporated (hereinafter also referred to as “Example”) and an open-type ball bearing into which a retainer that does not have the configuration of the present invention was incorporated (hereinafter also referred to as “Comparative Example”) were prepared, and those ball bearings were brought to an environment with a temperature of 30° C. Then, torque given by the operation under the lubrication conditions (1) and (2) described below was measured. As Example, the ball bearing into which the retainer according to the first embodiment illustrated in FIG. 1 to FIG. 4 was incorporated was used. As Comparative Example, the ball bearing into which the retainer having the configuration disclosed in FIG. 4(a) of Patent Literature 1 was incorporated was used. For measurement of torque, the ball bearings according to Example and Comparative Example were operated under a condition in which a radial load of 500 N was applied.

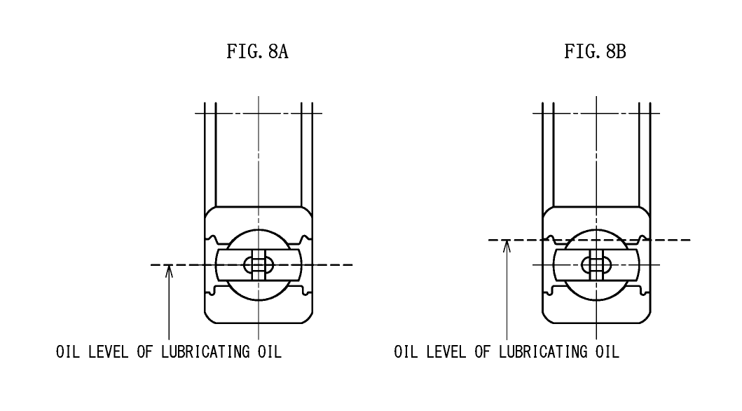

(1) Of the ball bearing in a vertical posture with an axial line arranged along a horizontal direction, a lower half of the region arranged on the lowermost side of the retainer was immersed in the lubricating oil (see FIG. 8A).

(2) Of the ball bearing in a vertical posture with the axial line arranged along the horizontal direction, the region arranged on the lowermost side of the retainer was fully immersed in the lubricating oil (see FIG. 8B).

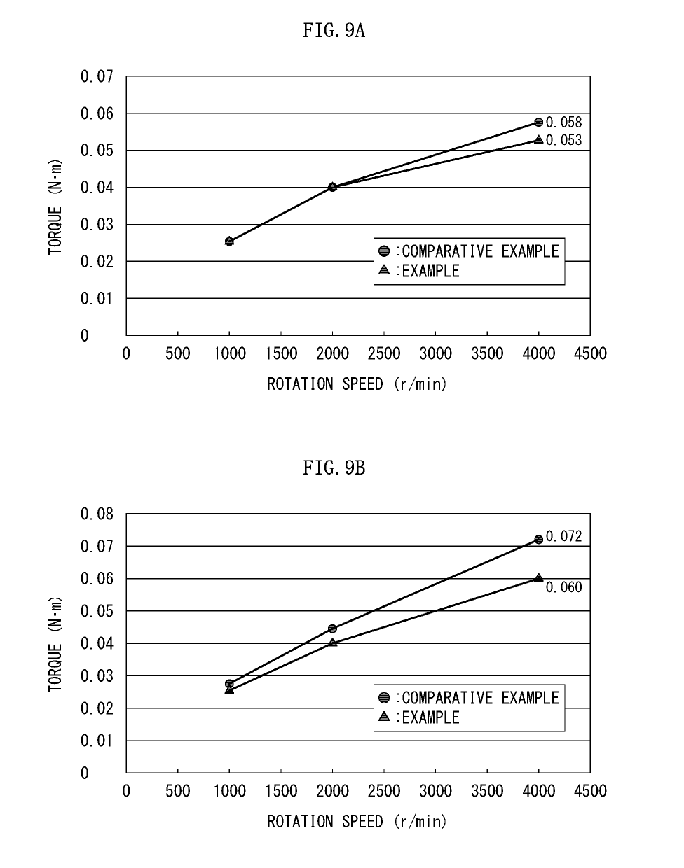

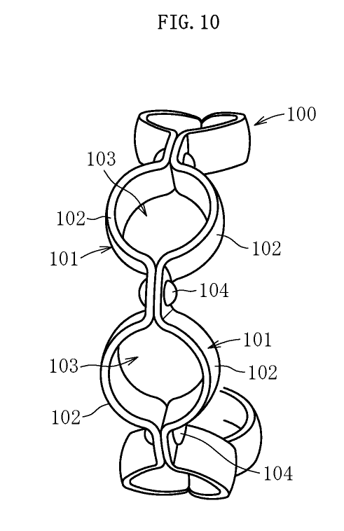

In FIG. 9A, there is shown a torque measurement result that was given in the case in which the deep groove ball bearings according to Example and Comparative Example were operated under the above-mentioned lubrication condition (1). In FIG. 9B, there is shown a torque measurement result that was given in the case in which the deep groove ball bearings according to Example and Comparative Example were operated under the above-mentioned lubrication condition (2).

As shown in FIG. 9A, in the case in which the above-mentioned lubrication condition (1) was employed, when the rotation speed was equal to or lower than 2,000 rpm, there was no substantial difference in torque between Example and Comparative Example. However, when the rotation speed was equal to or higher than 2,000 rpm, the torque was lower in Example. Further, as shown in FIG. 9B, in the case in which the above-mentioned lubrication condition (2) was employed, even when the rotation speed was 1,000 rpm, Example was lower in torque than Comparative Example, and the difference in torque between Example and Comparative Example increased as the rotation speed increased. From such torque measurement results, in the case in which the configuration of the present invention is employed, the lubricating oil interposed between the pocket 11 and the ball 6 can be smoothly (efficiently) discharged to the outside of the retainer 7 during the operation of the ball bearing. Therefore, it can be understood that the configuration of the present is beneficial in view of achieving the ball bearing with low torque.

### REFERENCE SIGNS LIST

1 ball bearing (deep groove ball bearing)
2 outer ring
4 inner ring
6 ball
7 retainer
8 annular member
9 semi spherical bulging portion
11 pocket
12 ball-opposed surface
13 protruding portion
14 ball non-contact portion
A predetermined region
L straight line
P intersection

1. A retainer, comprising a pair of annular members each having semi spherical bulging portions arrayed at predetermined intervals along a circumferential direction, the pair of annular members being coupled to each other so that the semispherical bulging portions which are opposed to each other form pockets configured to retain balls,
the pockets each comprising a ball-opposed surface having a ball non-contact portion that is recessed toward a side opposite to the ball side,
the ball non-contact portion being formed outside a predetermined region of the ball-opposed surface, which includes an intersection of a pitch circle of the balls and a straight line extending in a radial direction through a central portion of the ball-opposed surface in the circumferential direction, and having an end portion on a radially outer side which is opened in a radially outer surface of the annular member.

2. The retainer according to claim 1, wherein the ball non-contact portion has a wedge-shaped cross section which gradually increases in separation distance with respect to the ball from a radially inner side to the radially outer side.

3. The retainer according to claim 1, wherein an end portion of the ball non-contact portion on the radially inner side is opened in a radially inner surface of the annular member.

4. The retainer according to claim 1, wherein the ball non-contact portion is formed at each of two locations apart in the circumferential direction.

5. The retainer according to claim 1, wherein a protruding portion which protrudes toward the side opposite to the ball side is formed on the semi spherical bulging portion to form the ball non-contact portion.

6. The retainer according to claim 1, wherein the pair of annular members are any one product selected from the group consisting of a press-formed product, a casted product, a machined product, and an injection-molded product.

7. A deep groove ball bearing, comprising:
an inner ring and an outer ring which rotate relative to each other through intermediation of a plurality of balls; and
the retainer of claim 1, which is arranged between the inner ring and the outer ring, and is configured to retain the plurality of balls.

8. The deep groove ball bearing according to claim 7, wherein the deep groove ball bearing is to be used through incorporation into a transmission.
